(19) United States
(12) Patent Application Publication
(10) Pub. No.: US 2004/0239970 A1
(43) Pub. Date: Dec. 2, 2004

(54) Image reading apparatus, image formation apparatus and method for detecting document area

(75) Inventor: Tetsuya Niitsuma, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Minolta Business Technologies, Inc., Tokyo (JP)

(21) Appl. No.: 10/783,372

(22) Filed: Feb. 20, 2004

(30) Foreign Application Priority Data
May 28, 2003 (JP) 2003-150954

(51) Int. Cl. G06F 15/00; H04N 1/04; H04N 1/48; H04N 1/56; G06K 9/78; G06K 9/80; G06T 7/60

(52) U.S. Cl. 358/1.9; 358/488; 358/505; 358/514; 382/165; 382/286; 358/449

(57) ABSTRACT

An image reading apparatus has: image sensors having different spectral characteristics from one another; a layered image generation section for generating layered image data based on an output from the image sensors; a comparison section for comparing a threshold of each layered image data against a pixel value of each layered image data, the threshold being predetermined corresponding to each layered image data, and for judging existence of a document image on each pixel; an estimated document area determination section for determining an estimated document area of each layered image data based on a result of judging the existence by the comparison section; a document area detection section for detecting a document area on the basis of the estimated document area of each layered image data; and a document reading section for reading a document on the basis of the document area detected by the document area detection section.

### BACKGROUND OF THE INVENTION

1. Field of the Invention

This invention relates to an image reading apparatus, an image formation apparatus and a method for detecting a document area, each capable detecting a document area.

2. Description of the Related Art

With the use of an image reading apparatus in earlier art, an image is read in the following way. A light source irradiates light to a document placed on a platen and the light reflected from the document is converted into electrical signals by photoelectric conversion elements. When an image is to be read from a thick object such as a book or the like, since a platen cover, which is openably mounted on the platen, is opened, light is irradiated to an area on the platen not covered with the document (a non-document area), that is to say, an area on the platen where an object which reflects light emitted from the light source does not exist (hereinafter, it is called “skyshot”). In this case, intensity of the reflected light is approximately zero. As a result, when a read image is to be output, the non-document area becomes black. To avoid such a situation, an image reading apparatus for forming an image of only a document area on a platen by distinguishing between a document area and a non-document the area on the platen has been proposed (see, for example, Japanese Patent Application Publication (Unexamined) No. 2002-84409).

One of methods for distinguishing between a document area and a non-document area is to compare brightness data values obtained as electrical signals against a predetermined threshold and to detect an area of which the brightness value is not less than the threshold as a document area. As shown in FIG. 15, a document 61 is placed on a platen 60 of an image reading apparatus and an image thereof is to be read. Practically, the document 61 is placed on the platen 60 with its surface down. On the document 61, drawn is a picture of a white (bright) person 63 with a light-colored background 62 behind. A portion of which the brightness value is not less than a threshold TH is detected as a document area.

However, the above-mentioned earlier art is an art in regard to a monochrome image reading apparatus. That is to say, with the above-mentioned earlier art, a document area is detected only on the basis of monochrome density and brightness. Therefore, if a document is, for example, of deep blue, deep red or the like, misdetection of a document area may happen.

As shown in FIG. 16, when an image is to be read while a document 64 in which a white person 66 is drawn with a deep blue background behind is placed on the platen 60 of the image reading apparatus, since a brightness signal of the background part of the document among brightness signals obtained from the scan line Z is smaller than the threshold TH, the background area is not detected as a document area.

### SUMMARY OF THE INVENTION

The present invention is made in view of the problem of the above-mentioned earlier art. An object of the present invention is to provide an image reading apparatus, an image formation apparatus and a method for detecting a document area, each capable of detecting a document area accurately.

An image reading apparatus comprises: a plurality of image sensors having different spectral characteristics from one another; a layered image generation section for generating a plurality of pieces of layered image data on the basis of an output from the plurality of image sensors; a comparison section for comparing a threshold of each of the plurality of pieces of layered image data against a pixel value of each of the plurality of pieces of layered image data, the threshold being predetermined corresponding to each of the plurality of pieces of layered image data, and for judging existence of a document image on each pixel; an estimated document area determination section for determining an estimated document area of each of the plurality of pieces of layered image data on the basis of a result of judging the existence by the comparison section; a document area detection section for detecting a document area on the basis of the estimated document area of each of the plurality of pieces of layered image data; and a document reading section for reading a document on the basis of the document area detected by the document area detection section.

Here, the layered image data means, for example, either R image data, G image data and B image data obtained by sensors having spectral sensitivity which respectively peaks at R, G and B, or image data generated on the basis of the R, G, B image data.

Further, to determine existence of a document image on each pixel, if a pixel has higher brightness (brighter) than a threshold as standard, the pixel is determined that a document image exists, while if a pixel has lower brightness (darker) than the threshold, the pixel is determined that a document image does not exist. For example, if layered image data is described as brightness, a pixel having brightness equal to or higher than the threshold is determined that a document image exists and a pixel having brightness lower than the threshold is determined that a document image does not exist, and if layered image data is described as density, a pixel having density equal to or lower than the threshold is determined that a document image exists and a pixel having density higher than the threshold is determined that a document image does not exist.

According to the image reading apparatus of the first aspect of the present invention, since a document area is detected on the basis of estimated document areas of each layered image data, the document area can be detected accurately even in the case that the document is of deep color. In addition, since a document is read on the basis of the document area detected by the document area detection section, an image can be read efficiently.

Preferably, in the apparatus of the first aspect of the present invention, the document area detection section detects an area included in any one of the estimated document area of each of the plurality of pieces of layered image data as the document area.

According to the above-mentioned apparatus, since an area included in any one of the estimated document areas of each layered image data is detected as a document area, the document area can be detected accurately with the use of simple calculation.

Preferably, in the apparatus of the first aspect of the present invention, the plurality of image sensors include a color image sensor comprising three sensors having spectral sensitivity which respectively peaks at R (red), G (green) and B (blue).

According to the above-mentioned apparatus, since three sensors having spectral sensitivity which respectively peaks at R, G and B are used, a document area can be detected accurately even in the case that the document is of deep blue, deep red or the like. In addition, since a color image sensor included in a color image reading apparatus can be used for detecting a document area, it is possible to detect a document area according to human visual properties.

Preferably, in the apparatus of the first aspect of the present invention, the threshold of each of the plurality of pieces of layered image data is changeable.

According to the above-mentioned apparatus, since a threshold used for determining existence of a document image can be changed, a document area can be detected flexibly according to a document and an environment.

Preferably, the apparatus of the first aspect of the present invention further comprises: a platen on which the document is placed; a platen cover openably mounted on the platen; and a platen cover open detection section for detecting an opened state of the platen cover, wherein operation of detecting the document is performed on the basis of a signal output from the platen cover open detection section.

According to the above-mentioned apparatus, since operation of detecting a document is performed on the basis of a signal output from the platen cover open detection section, a reading error can be minimized.

Preferably, the apparatus of the first aspect of the present invention further comprises an automatic threshold setting section for setting the threshold of each of the plurality of pieces of layered image data on the basis of a signal output from the plurality of image sensors in a state that the platen cover open detection section detects the opened state of the platen cover and the document is not placed on the platen.

According to the above-mentioned apparatus, since a threshold of each layered image data is set on the basis of output from the plurality of image sensors in the state that the platen cover is opened and a document is not placed on the platen, a document area can be detected according to an environment.

Preferably, in the apparatus of the first aspect of the present invention, the estimated document area determination section determines an effective image area of each scan line on the basis of information regarding an area where not less than predetermined number of pixels which are judged as the pixel on which the document image exists by the comparison section are continuously lined up in each scan line, and determines a smallest rectangular area that includes all the effective image area of each scan line as the estimated document area.

Here, an effective image area is an area including two most distant areas and inside of the two most distant areas among areas where not less than predetermined number of pixels which are judged as a pixel on which a document image exists in each scan line are continuously lined up in the scan line. If a pixel area which is determined that a document image exists is continuous in the scan line, an effective image area is the continuous area.

According to the above-mentioned apparatus, since the smallest rectangular area including all the effective image areas in each scan line is determined as an estimated document area, a document area can be detected regardless of disturbance.

Preferably, in the apparatus of the first aspect of the present invention, the estimated document area determination section determines an effective image area of each scan line on the basis of information regarding an area where not less than predetermined number of pixels which are judged as the pixel on which the document image exists by the comparison section are continuously lined up in each scan line, and determines an area included in both an effective area in a previous line and an effective area in a current line as the estimated document area of the current line.

Here, the current line is a scan line of interest currently, and the previous line is a scan line read one before the current line by the image sensor among lines next to the current line.

According to the above-mentioned apparatus, since an area included in both an effective image area in the previous line and an effective image area in the current line is determined as an estimated document area in the current line, a document area can be detected flexibly according to the shape of the document.

In accordance with a second aspect of the present invention, an image formation apparatus comprises: a plurality of image sensors having different spectral characteristics from one another; a layered image generation section for generating a plurality of pieces of layered image data on the basis of an output from the plurality of image sensors; a comparison section for comparing a threshold of each of the plurality of pieces of layered image data against a pixel value of each of the plurality of pieces of layered image data, the threshold being predetermined corresponding to each of the plurality of pieces of layered image data, and for judging existence of a document image on each pixel; an estimated document area determination section for determining an estimated document area of each of the plurality of pieces of layered image data on the basis of a result of judging the existence by the comparison section; a document area detection section for detecting a document area on the basis of the estimated document area of each of the plurality of pieces of layered image data; a document reading section for reading a document on the basis of the document area detected by the document area detection section; and an image formation section for forming an image on the basis of image data of the document read by the document reading section.

According to the apparatus of the second aspect of the present invention, since a document area is detected on the basis of estimated document areas of each layered image data, the document area can be detected even in the case that the document is of deep color. Further, since a document is read based on the document area detected by the document area detection section, an image can be read efficiently.

In accordance with a third aspect of the present invention, a method for detecting a document area comprises: generating a plurality of pieces of layered image data on the basis of an output from a plurality of image sensors having different spectral characteristics from one another; comparing a threshold of each of the plurality of pieces of layered image data against a pixel value of each of the pieces of layered image data, the threshold being predetermined corresponding to each of the plurality of pieces of layered image data, for judging existence of an document image on each pixel; determining an estimated document area of each of the plurality of pieces of layered image data on the basis of a result of judging the existence of the document image; and detecting a document area on the basis of the estimated document area of each of the plurality of pieces of layered image data.

According to the method of the third aspect of the present invention, since a document area is detected based on estimated document areas of each layered image data, the document area can be detected accurately even in the case that the document is of deep color.

Preferably, in the method of the third aspect of the present invention, the plurality of image sensors include a color image sensor comprising three sensors having spectral sensitivity which respectively peaks at R (red), G (green) and B (blue).

According to the above-mentioned method, since three sensors having spectral sensitivity which respectively peaks at R, G and B, a document area can be detected accurately even in the case that the document is of deep blue, deep red or the like.

Preferably, in the method of the third aspect of the present invention, the threshold of each of the plurality of pieces of layered image data is changeable.

According to the above-mentioned method, since a threshold for determining existence of a document image on each pixel can be changed, a document area can be detected according to a document and an environment.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a sectional view showing a structure of an image formation apparatus 11,

FIG. 2 is a view for describing a platen cover 15 and a platen cover open detection section 19,

FIG. 3A is a top view of the platen cover open detection section 19,

FIG. 3B is a side view of the platen cover open detection section 19,

FIG. 4 is a block diagram showing a functional structure of the image formation apparatus 11,

FIG. 5 is an example of histogram data,

FIG. 6 is an example of histogram data obtained when external light is detected,

FIG. 7 is a flow chart showing processes performed by the image formation apparatus 11,

FIG. 8 is an image process block diagram showing a rectangular document area detection process,

FIGS. 9A and 9B are views for describing how to determine an effective image area,

FIG. 10 is a view for describing how to determine an effective image area in a scan line X,

FIG. 11 is a view showing an example of detecting a document area according to the rectangular document area detection process,

FIG. 12 is an image process block diagram showing a non-rectangular document area detection process,

FIG. 13 is a view for describing how to determine an estimated document area and detect a document area in a non-rectangular document area detection process,

FIG. 14A is a view showing an example of a document to be an object of the document area detection,

FIG. 14B is a view showing an example of a result of the rectangular document area detection process,

FIG. 14C is a view showing an example of a result of the non-rectangular document area detection process,

FIG. 15 is a view showing a method for detecting a document area in an earlier art, and

FIG. 16 is a view showing a problem with the method for detecting a document area in an earlier art.

### PREFERRED EMBODIMENT OF THE INVENTION

An embodiment of the present invention will be described in detail with reference to figures. However, the scope of the present invention is not limited to the examples shown in the figures.

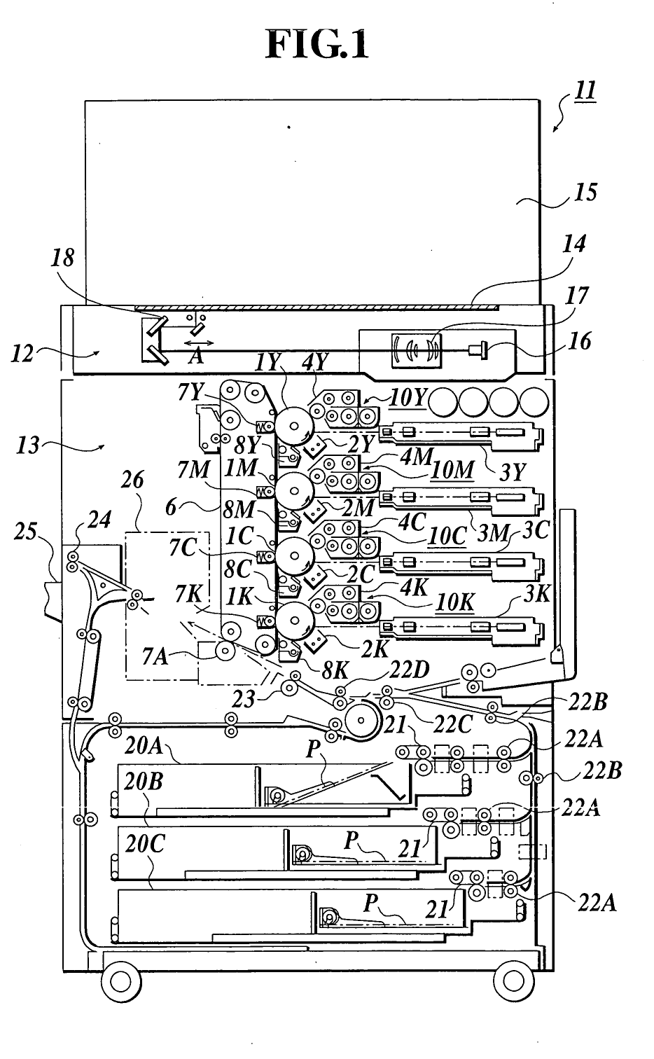

FIG. 1 is a sectional view showing a structure of an image formation apparatus 11. As shown in FIG. 1, the image formation apparatus 11 comprises an image reading device 12 and an image formation section 13.

The image reading device 12 according to the present invention comprises a platen 14 on which a document is to be placed, a platen cover 15 openably mounted on the platen 14, a light source (not shown) for irradiating light to the document, an image sensor 16, a lens 17, a group of mirrors 18 and the like.

Light irradiated from the light source is reflected at the document placed on the platen 14, then is focused by the lens 17 through the group of mirrors 18, and is read by the image sensor 16. The image sensor 16 is a color image sensor having three line sensors with spectral sensitivity which respectively peaks at red (R), green (G) and blue (B) In each line sensor, imaging devices having a photoelectric conversion function are arranged one-dimensionally. Light received by these imaging devices is converted into electrical signals. The light source and the group of mirrors 18 move in direction A indicated by an arrow in FIG. 1 and an image of the entire document placed on the platen 14 is read.

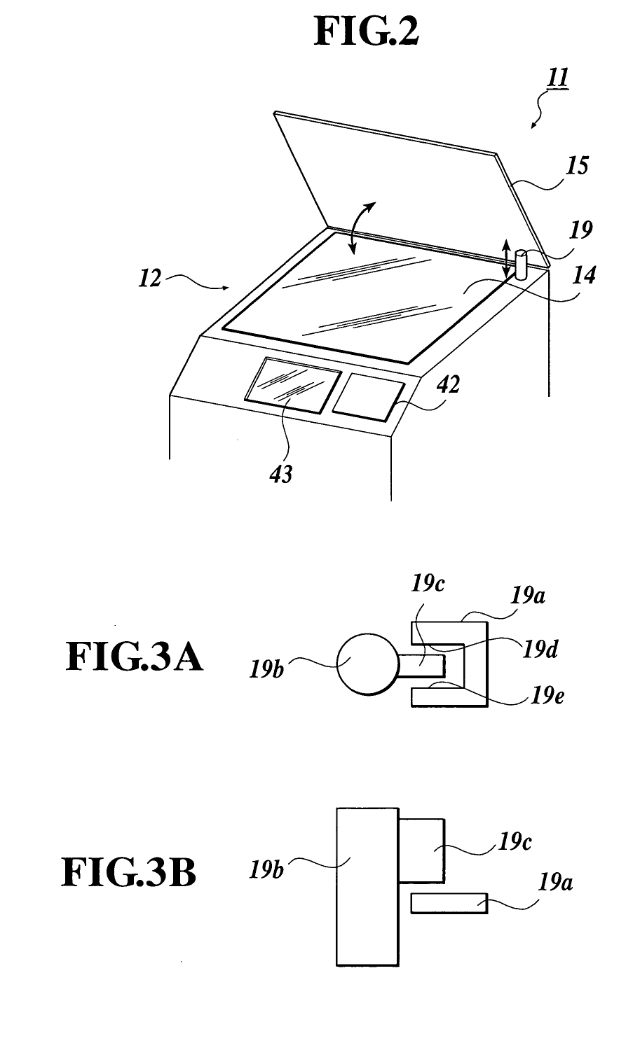

As shown in FIG. 2, a side of the platen cover 15 approximately corresponds to a side of the platen 14. When the platen cover 15 is closed, the platen cover 15 can cover the platen 14 so that external light does not enter.

The image reading device 12 comprises a platen cover open detection section 19 for detecting the opened state of the platen cover 15. FIG. 3A is a top view of the platen cover open detection section 19 and FIG. 3B is a side view of the platen cover open detection section 19, respectively. The platen cover open detection section 19 comprises a photosensor 19a and a cylindrical dog 19b having a protruding portion 19c. The photosensor 19a has a shape of approximately the letter “U” sideways and a light-emitting section and a light receiving section are respectively located on a side 19d and a side 19e, which are opposed to each other, of the photosensor 19a. When the platen cover 15 is opened, the platen cover open detection section 19 is in a state shown in FIG. 3B and light emitted from the light-emitting section reaches the light receiving section. At this time, the platen cover open detection section 19 outputs a signal indicating that the platen cover 15 is in an opened state to a CPU 31. When the platen cover 15 is closed, a head of the dog 19b is pushed down by the platen cover 15 and the protruding portion 19c is moved down to the photosensor 19a. Accordingly, light emitted from the light-emitting section is shut out. As stated, the opened state of the platen cover 15 can be detected in-such a way by the platen cover open detection section 19.

As shown in FIG. 1, the image formation section 13 comprises image output sections 10Y, 10M, 10C and 10K, an intermediate transfer belt 6, a paper feeding conveyance mechanism composed of a sending-out roller 21, feeding paper roller 22A, conveyance rollers 22B, 22C and 22D, a registering roller 23, a paper outputting roller 24 and the like, a fixing unit 26 and the like.

The image output section 10Y for forming a yellow (Y) image comprisesa photosensitive drum 1Y as an image formation body, and a charged section 2Y, an exposure section 3Y, a development unit 4Y and an image formation body cleaning section 8Y, which are located around the photosensitive drum 1Y. Similarly, the image output section 10M for forming a magenta (M) image comprises a photosensitive drum 1M, a charged section 2M, an exposure section 3M, a development unit 4M, and an image formation body cleaning section 8M. The image output section 10C for forming a cyan (C) image comprises a photosensitive drum 1C, a charged section 2C, an exposure section 3C, a development unit 4C, and an image formation body cleaning section 8C. The image output section 10K for forming a black (K) image comprises a photosensitive drum 1K, a charged section 2K, an exposure section 3K, a development unit 4K, and an image formation body cleaning section 8K.

The image sensor 16 photoelectrically converts light into electrical signals, and various kinds of image processes are performed on the electrical signals to be sent to the exposure sections 3Y, 3M, 3C and 3K as image output data.

The intermediate transfer belt 6 is supported by a plurality of rollers so as to be capable of rotating around the rollers. The development units 4Y, 4M, 4C and 4K perform image development according to inversion phenomenon where a developing bias obtained by superimposing alternating current voltage on direct current voltage having the same polarity as that of toner being used is applied

Images in each color formed by the image output sections 10Y, 10M, 10C and 10K are sequentially transferred onto the intermediate transfer belt 6 rotating by primary transfer rollers 7Y, 7M, 7C and 7K, to which a primary transfer bias having polarity opposite to that of the toner to be used is applied (primary transfer) and then a composite color image is formed (color toner image).

Recording paper P held in paper cartridges 20A, 20B and 20C is fed by the feed roller 21 and the feed paper roller 22A, each placed in the paper cartridges 20A, 20B and 20C, and after being fed through the conveying rollers 22B, 22C and 22D and a registering roller 23, then a color image is at once transferred onto one side of the recording paper P (secondary transfer).

The recording paper P onto which the color image has been transferred is fixed by the fixing unit 26, then is pinched by a paper outputting roller 24, and then is outputted on a paper outputting tray 25, which is located outside of the apparatus.

Remaining toner on the surfaces of the photosensitive drums 1Y, 1M, 1C and 1K is cleaned up by the image formation body cleaning sections 8Y, 8M, 8C and 8K, respectively. Then the operation proceeds to the next image formation cycle.

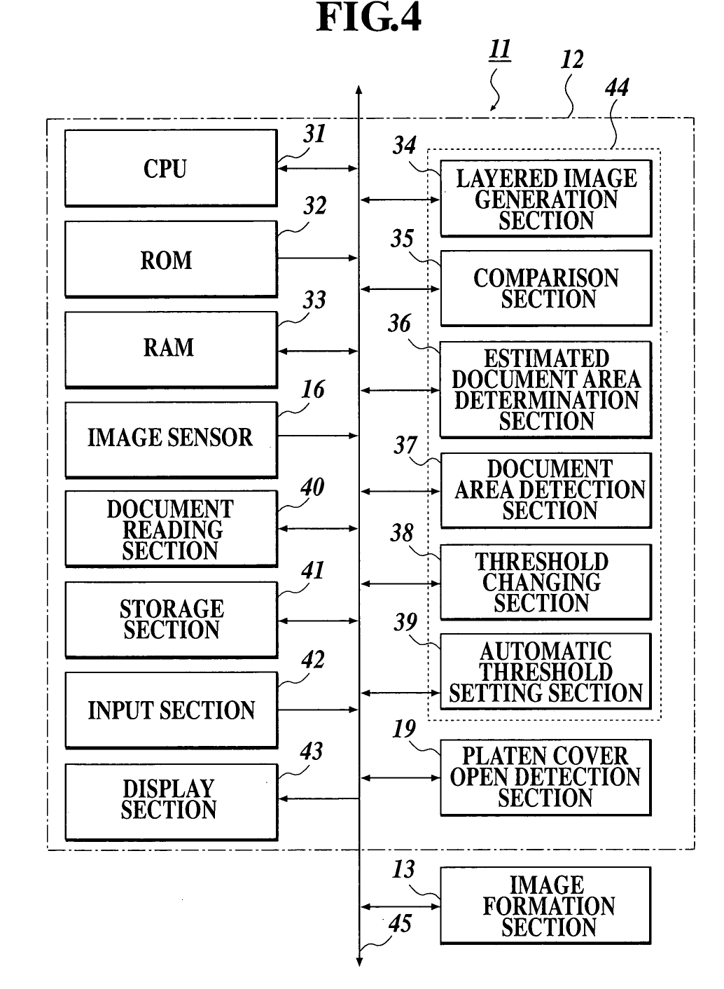

FIG. 4 shows a functional structure of the image formation apparatus 11.

As shown in FIG. 4, the image formation apparatus 11 comprises a CPU (Central Processing Unit) 31, a ROM (Read Only Memory) 32, a RAM (Random Access Memory) 33, the image sensor 16, a document reading section 40, a storage section 41, an input section 42, a display section 43, an image data process section 44, the platen cover open detection section 19 and the image formation section 13, each connected to one another through a bus 45.

In accordance with various instructions input from the input section 42, the CPU 31 loads a program designated among various programs stored in the ROM 32 or the storage section 41, develops it into a work area in the RAM 33, performs various processes in cooperation with the above-mentioned program, and makes each section in the image formation apparatus 11 function. At this time, the CPU 31 stores a result of the processes in a predetermined area in the RAM 33 as well as makes the display section 43 display the result according to need.

The ROM 32 is a semiconductor memory used solely for reading and the ROM 32 stores basic programs to be executed by the CPU 31, data and the like.

The RAM 33 is a storage medium in which data is stored temporarily. In the RAM 33, formed are a program area for developing a program to be executed by the CPU 31, a data area for storing data input from the input section 42 and a result of the various processes performed by the CPU 31, and the like.

The image data process section 44 comprises a layered image generation section 34, a comparison section 35, an estimated document area determination section 36, a document area detection section 37, a threshold changing section 38, and an automatic threshold setting section 39.

The layered image generation section 34 performs an analog signal process and an A/D conversion process on an electrical signal output from the image sensor 16, synchronizes the timing of the R, G, B line sensors by performing an in-line correction process for correcting a delay among the R, G, B line sensors in main scanning direction and an in-line delay process for correcting a delay among the R, G, B line sensors in sub scanning direction, and then generates layered image data. Each layered image data generated by the layered image generation section 34 is stored in the storage section 41.

The comparison section 35 compares a threshold corresponding to each layered image data stored in the storage unit 41 against pixel values of each layered image data, and determines existence of a document image on each pixel.

The estimated document area determination section 36 determines an estimated document area of each layered image data based on a result of the determination by the comparison section 35.

The document area detection section 37 detects an area included in any one of the estimated document areas of each layered image data (hereinafter, it is called OR area) as a document area.

The threshold changing section 38 changes the threshold, which is to be compared against the pixel values of each layered image data by the comparison section 35, to a value input from the input section 42 and stores the value in the storage section 41.

The threshold of each layered image data may be set per each layered image data on the basis of an ordinary image, may be changed to a value that a user desires by the threshold changing section 38, or may be calculated according to each document. When a threshold is to be set, for example, the light source irradiates light to a document placed on the platen 14, the light reflected from the document is photoelectrically converted by the image sensor 16, and histogram data is created on the basis of brightness data values, which is the electrical signals obtained from the conversion. For example, as shown in FIG. 5, in the histogram data, a horizontal axis indicates brightness data values and a vertical axis indicates frequency of each brightness data value obtained according to the entire platen 14.

A peak P1 at the left side of FIG. 5 indicates that lots of brightness data values corresponding to very low brightness, that is, little amount of reflected light of the light from the light source, are obtained. In other words, it is estimated that the peak P1 is a preliminary result of brightness data values obtained by “skyshot”.

On the other hand, a peak P2 at the right side of FIG. 5 indicates that lots of brightness data values corresponding to very high brightness, that is, large amount of the reflected light having high intensity of the light from the light source, are detected. This leads to the speculation that the document placed on the platen 14 is white because usually a no-image area of document is larger than an image area of the document. In addition, that the reflected light has high intensity is a strong evidence to show that the reflecting surface is white. Peaks P3 and P4 in FIG. 5 are based on light reflected at an image (characters and the like) formed on the document.

Therefore, a threshold TH should be set so as to have a value between a brightness data value A1 corresponding to the peak P1 obtained generally from a non-document area and a brightness data value A2 corresponding to the peak P2 obtained generally from a document area.

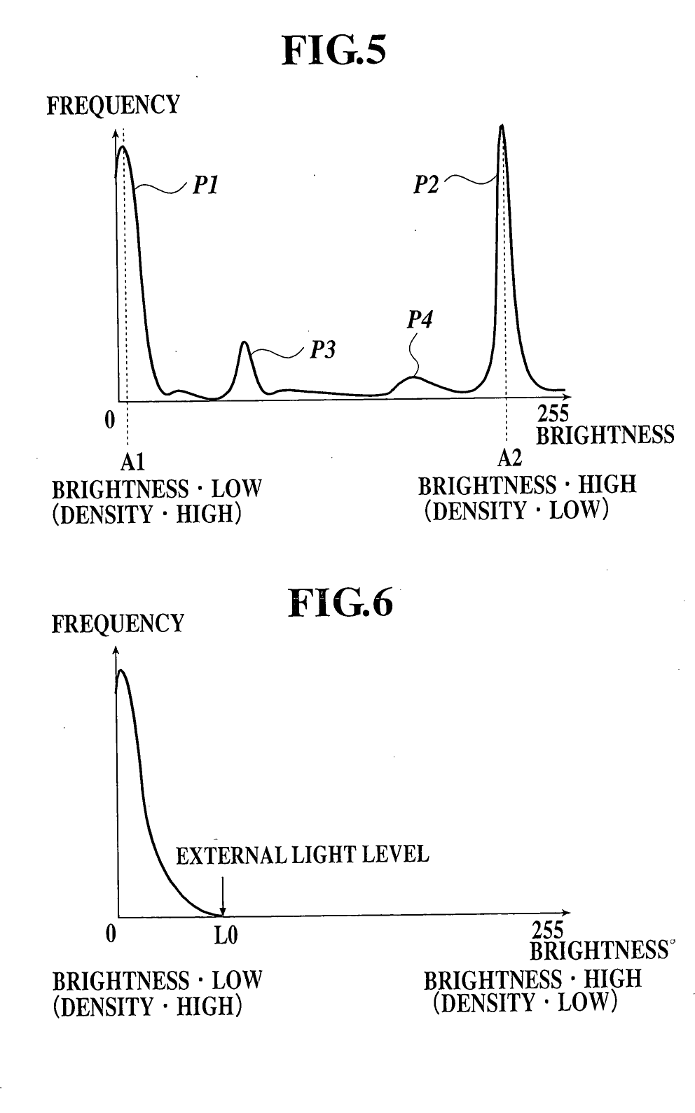

The automatic threshold setting section 39 sets a threshold of each layered image data based on an output result of the image sensor 16 in the state that the platen cover open detection section 19 detects the opened state of the platen cover 15 and a document is not placed on the platen 14. Concretely, as shown in FIG. 6, the automatic threshold setting section 39 obtains histogram data of external light in the state that the platen cover 15 is opened and nothing is placed on the platen 14, sets a maximum brightness value LO of the histogram data as the threshold TH, and then stores the threshold TH in the storage section 41.

The layered image generation section 34, the comparison section 35, the estimated document area determination section 36, the document area detection section 37, the threshold changing section 38 and the automatic threshold setting section 39 are respectively achieved by a software process in cooperation with programs stored in the ROM 32 and the CPU 31.

The document reading section 40 reads a document on the basis of a document area detected by the document area detection section 37.

The storage section 41 stores processing programs, processing data and the like for performing various processes according to the present embodiment. The processing data includes image data, a threshold of each layered image data and the like. When the CPU 31 gives the storage section 41 an instruction to store image data, the storage section 41 checks its free space and stores the designated image data in the free space. Moreover, when the CPU 31 gives the storage section 41 an instruction to load a program or data, the storage section 41 loads the designated program or data and outputs it to the CPU 31.

The input section 42 has numeric keys and various function keys (such as a start key and the like). When one of these keys is pushed, the input section 42 outputs the pushed signal to the CPU 31. Here, the input section 42 may be integrated with the display section 43 to be a touch panel.

The display section 43 is composed of an LCD (Liquid Crystal Display) panel and the like and displays a screen on the basis of a display signal from the CPU 31.

Next, operation performed by the image formation apparatus 11 will be described.

Here, before the description of the operation, it is assumed that programs for performing each process described in the following flowchart are stored in the ROM 32 or the storage section 41 in a form which can be read by the CPU 31 of the image formation apparatus 11, and the CPU 31 sequentially performs the operation in accordance with the programs.

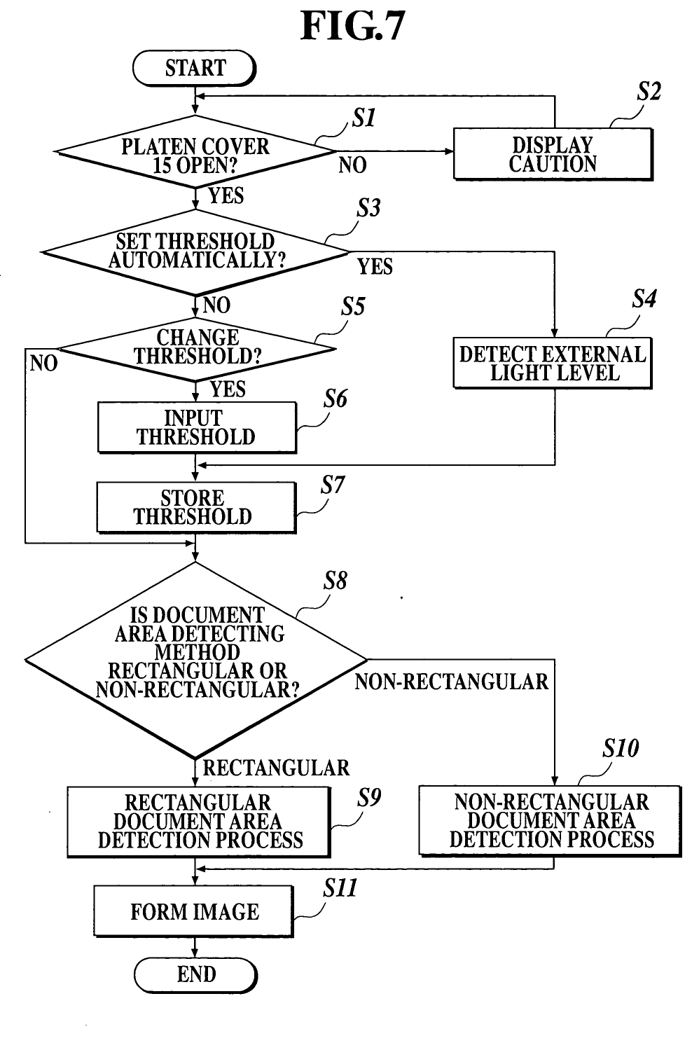

FIG. 7 is a flowchart showing processes performed by the image formation apparatus 11 in the present embodiment.

First, when “non-document area elimination function” for detecting a document area and reading the document on the basis of the detected document area is selected at the input section 42, the platen cover open detection section 19 detects whether the platen cover 15 is opened (Step S1). If the platen cover 15 is closed (Step S1; NO), an instruction to open the platen cover 15 is displayed on the display section 43 (Step S2).

Next, an instruction to choose whether to automatically set a threshold is displayed on the display section 43 and the choice is input at the input section 42 (Step S3).

If the threshold is to be set automatically (Step S3; YES), the automatic threshold setting section 39 obtains histogram data of external light (Step S4) and stores a maximum brightness value LO of the histogram data in the storage section 41 as a threshold TH (Step S7).

If the threshold is not to be set automatically (Step S3; NO), an instruction to choose whether to change the threshold is displayed on the display section 43 and the choice is input at the input section 42 (Step S5).

If the threshold is to be changed (Step S5; YES), a threshold value is input at the input section 42 (Step S6) and the threshold changing section 38 changes the threshold to the input value and stores the changed value in the storage section 41 (Step S7).

If the threshold is not to be changed (Step S5; NO), a threshold set for each layered image data on the basis of an ordinary image stored in the storage section 41 is used.

Next, an instruction to choose a rectangular document area detection process or a non-rectangular document area detection process as a method for detecting a document area is displayed on the display section 43 and either one is chosen at the input section 42 (Step S8).

The rectangular document area detection process (Step S9) will be described.

In the rectangular document area detection process, first, a scan (pre scan) is performed for detecting a document area, and then a scan (main scan) is performed for reading an image from the detected document area.

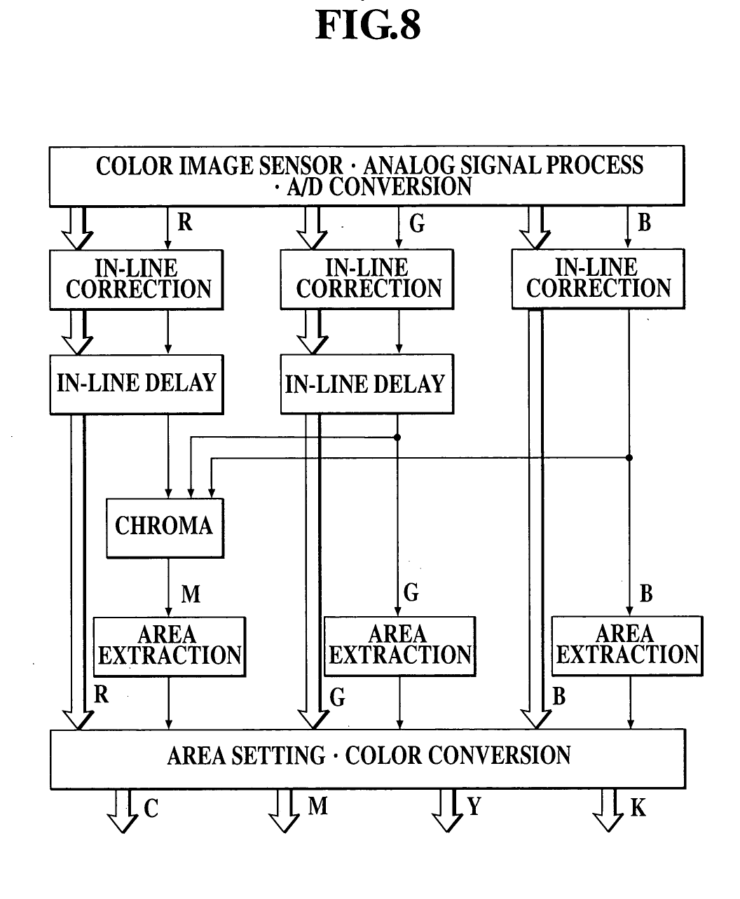

During the pre scan, processes are performed in the order of the black arrows shown in FIG. 8. First, the image sensor 16 which comprises the three R, G and B line sensors reads a document. To shorten the processing time, the pre scan is performed two times as fast as the main scan.

Next, the layered image generation section 34 performs an analog signal process and an A/D conversion process on an electrical signal output from the image sensor 16, synchronizes the timing of the R, G, B line sensors by performing an in-line correction process and an in-line delay process which correct a delay among the R, G, B line sensors, and then generates three types of layered image data, which are G image data generated from G (green) signals, B image data generated from B (Blue) signals and M (monochrome signal) image data generated from R, G, B signals. The monochrome signal M is obtained by transforming the R, G, B signals with the use of the following equation:

M=(R×300+G×600+B×124)/1024 (1)

(This process is referred to as chroma.)

Coefficients of this linear transformation may be different values according to a purpose. Each of the M, G, B layered image data generated by the layered image generation section 34 is stored in the storage section 41.

Next, the comparison section 35 compares the threshold of each layered image against pixel values of each layered image data and determines existence of a document image on each pixel.

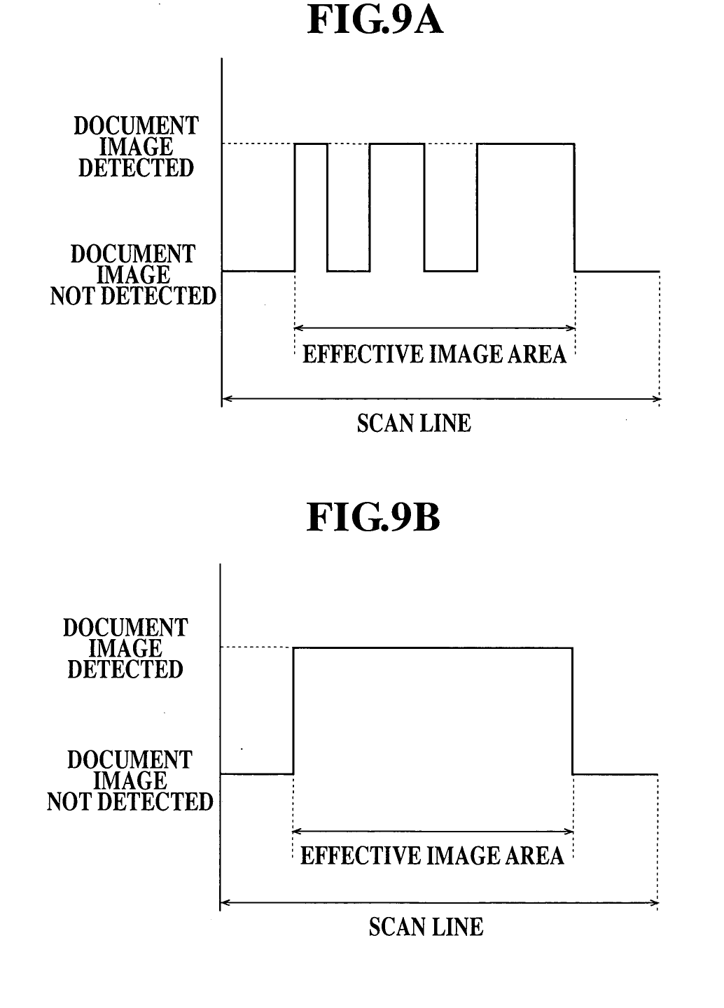

Then, as shown in FIG. 9A, the estimated document area determination section 36 determines an area including two most distant area from each other in a scan line and inside of the two most distant areas among areas where not less than predetermined number of pixels which are judged as ones on which a document image exists are continuously lined up in the scan line, as an effective image area in the scan line. Here, as shown in FIG. 9B, if a pixel area determined that a document image exists is continuous in a scan line, this continuous area is determined as an effective image area. By taking an area where not less than predetermined number of pixels judged as ones on which a document image exists are continuously lined up, influence from dust and noise can be minimized.

Next, the estimated document area determination section 36 determines the smallest rectangular area that includes all the effective image areas in each scan line as an estimated document area (area extraction). M, G, B estimated document areas are determined per each of the M, G, B layered image data.

Then, the document area detection section 37 detects an OR area among the M, G, B estimated document areas as a document area and sets the document area as a document reading area to be read by the document reading section 40. From the above-mentioned operation, the pre-scan is completed.

During the main scan, processes are performed in the order of white arrows shown in FIG. 8. The document reading section 40 reads the document on the basis of the set document reading area. First, an analog signal process and an A/D conversion process are performed on an electrical signal output from the image sensor 16. An in-line correction process and an in-line delay process for correcting a delay among the R, G, B line sensors are performed in order to synchronize the timing of the R, G, B line sensors.

Then, R, G, B image data is color-converted and is stored in the storage section 41 as C (cyan), M (magenta), Y (yellow) and K (black) image data. Here, in a non-document area, image output data is set as zero so that image formation should not be performed.

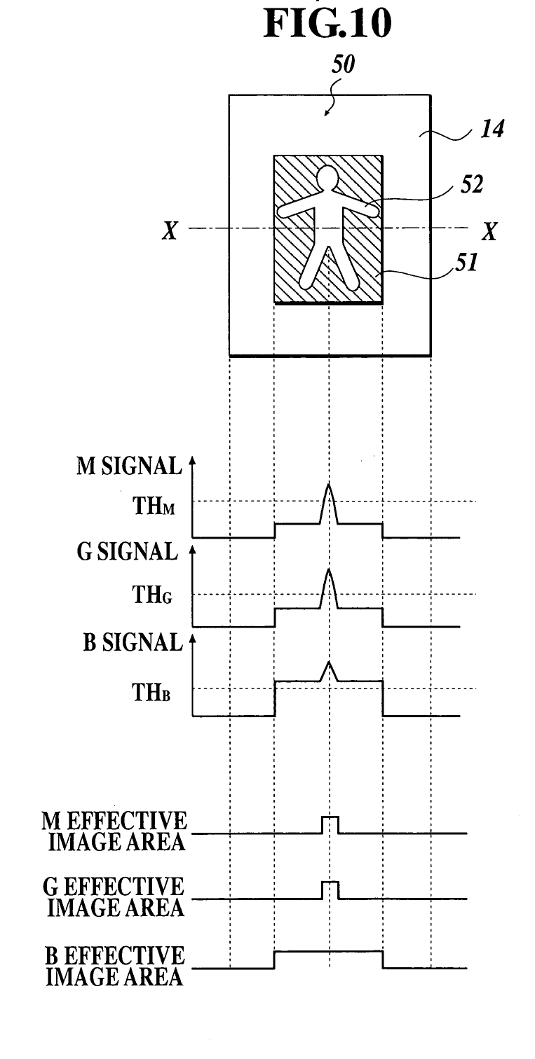

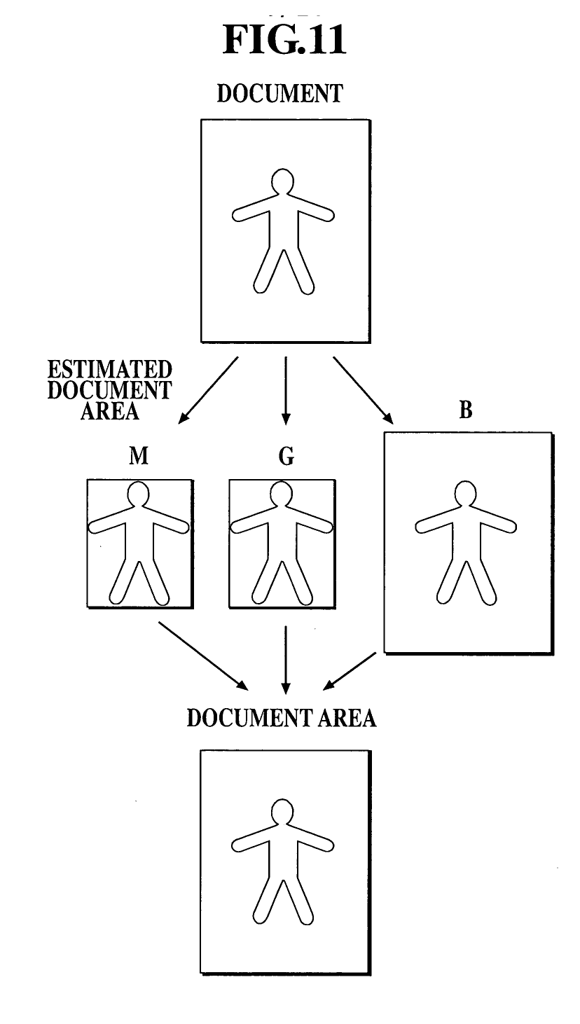

FIGS. 10 and 11 show examples to detect a document area according to the rectangular document area detection process. As shown in FIG. 10, a picture of a person 52 is drawn white with a deep blue background 51 behind on a document 50 placed on the platen 14. Practically, the document 50 is placed on the platen 14 with its surface down. FIG. 10 further shows layered image data corresponding to M, G, B obtained from the scan line X, and an effective image area in the scan line X obtained from each layered image data. An area where values of M signals, G signals and B signals are respectively not less than thresholds TH_{M}, TH_{G} and TH_{B} is determined as an effective image area obtained from each layered image data. As mentioned, an effective image area in each scan line is determined on the basis of each layered image data and the smallest rectangular area including all the effective image areas in each scan line is determined as an estimated document area of the layered image data.

As shown in FIG. 11, an estimated document area per each of the M, G, B layered image data is obtained from document with a deep blue background behind, and a document area is detected by taking an OR area of these estimated document areas.

If a document is of deep blue or the like, values of signals corresponding to brightness such as monochrome M signals or the like are small in a background area of the document. Therefore, it is hard to distinguish the background area of the document from the background of skyshot. However, since values of B signals are large, it is easy to distinguish the background area of the document from the background of skyshot. As a result, the document can be detected accurately. In other words, a document, which could not be detected with the use of monochrome signals or monochromatic signals, can be accurately detected by taking an OR area among estimated document areas obtained from a plurality of layered image data. In addition, since the smallest rectangular area including all the effective image areas in each scan line is determined as an estimated document area, a document area can be detected regardless of disturbance.

Next, the non-rectangular document area detection process (Step S10) will be described.

In the rectangular document area detection process, the main scan is performed after the pre scan. In the non-rectangular document area detection process, however, a document is detected and read by scanning once.

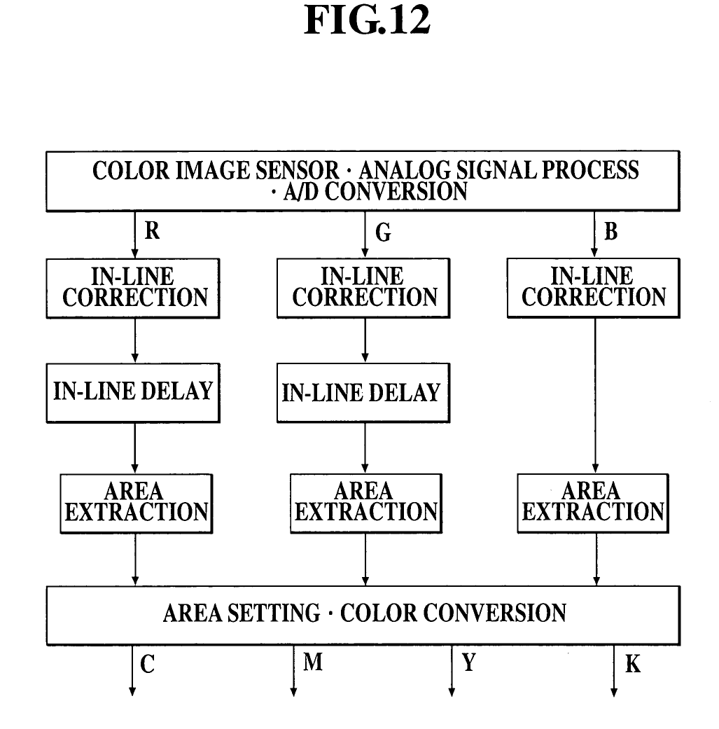

As shown in FIG. 12, the layered image generation section 34 performs an analog signal process and an A/D conversion process on an electrical signal output from the image sensor 16, synchronizes the timing of the R, G, B line sensors by performing an in-line correction process and an in-line delay process for correcting a delay among the R, G, B line sensors, and generates three types of layered image data, which are R image data generated from R (red) signals, G image data generated from G (green) signals and B image data generated from B (blue) signals. Each of the R, G, B layered image data generated by the layered image generation section 34 is stored in the storage section 41.

Next, the comparison section 35 compares a threshold of each layered image data against pixel values of each layered image data and determines existence of a document image on each pixel.

Then, the estimated document area determination section 36 determines an effective image area in each scan line in the same way as the rectangular document area detection process.

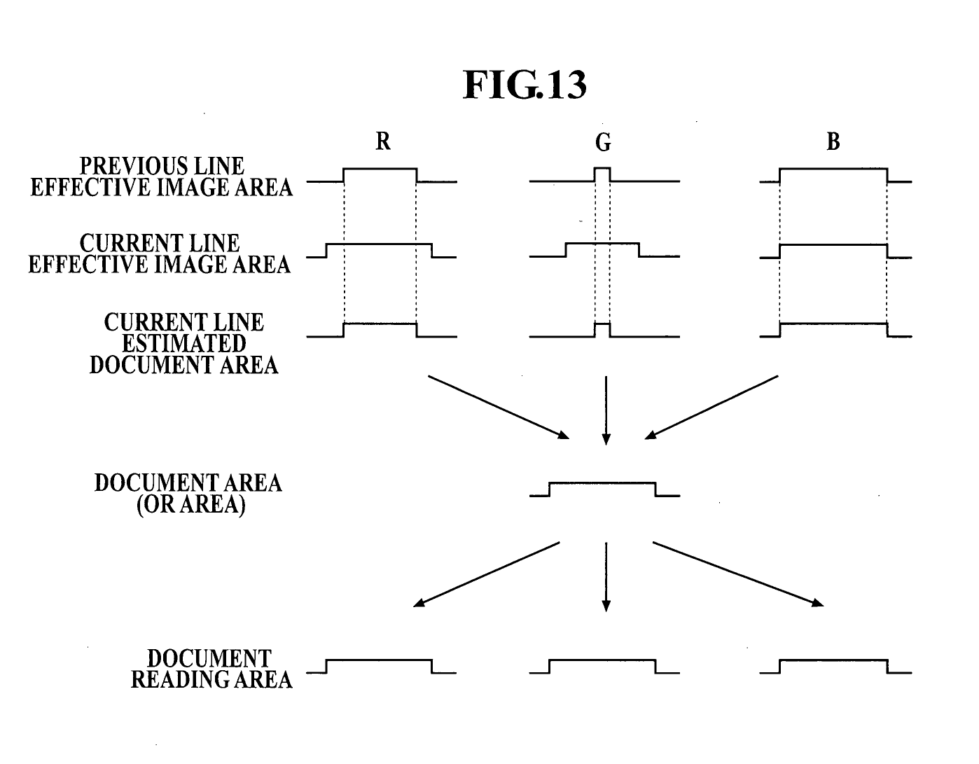

As shown in FIG. 13, an area included in both an effective image area in a previous line and an effective area in a current line (hereinafter, it is called as an AND area) per each of the R, G, B layered image data is determined as an estimated document area in the current line (area extraction). By taking an AND area between the effective image areas in adjacent scan lines, influence of dust and noise can be minimized.

Next, an OR area among the estimated document areas determined per each of the R, G, B layered image data is detected as a document area. A document reading area per each of R, G, B image data is set on the basis of the detected document area.

Then, the R, G, B image data is color-converted and is stored in the storage section 41 as C, M, Y, K image data. Here, in a non-document area, image data is set as zero so that image formation should not be performed.

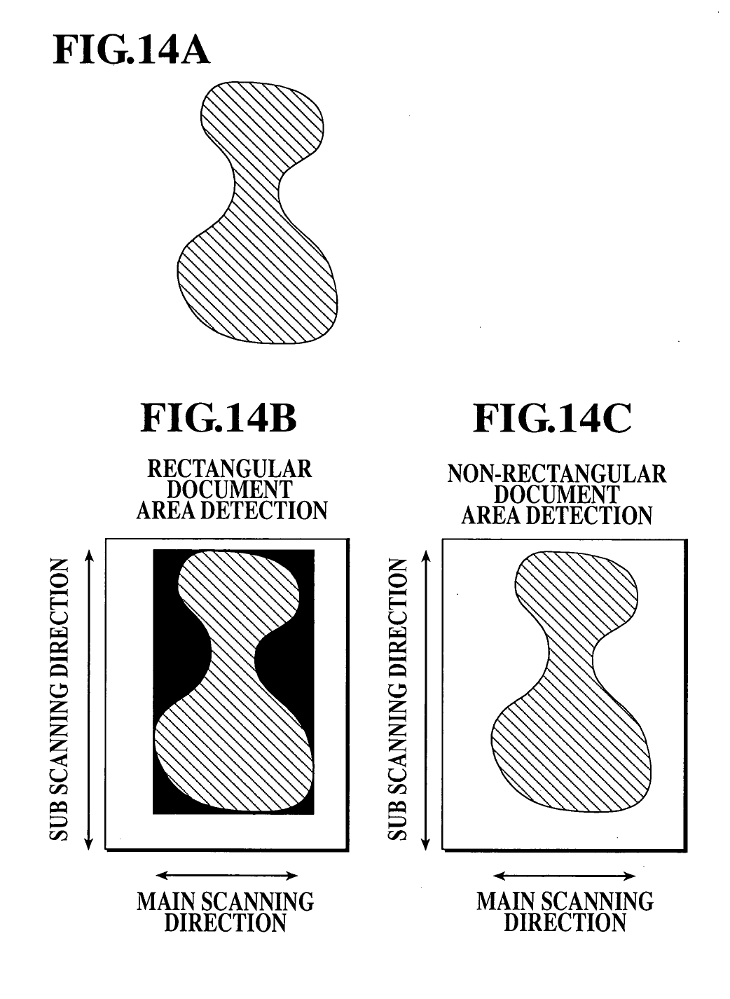

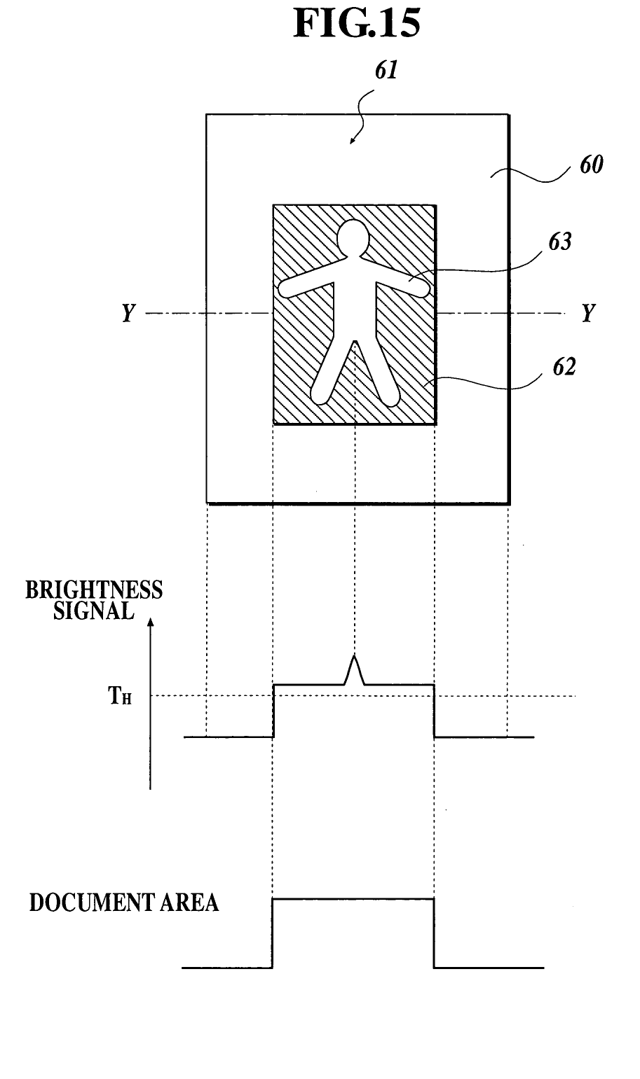

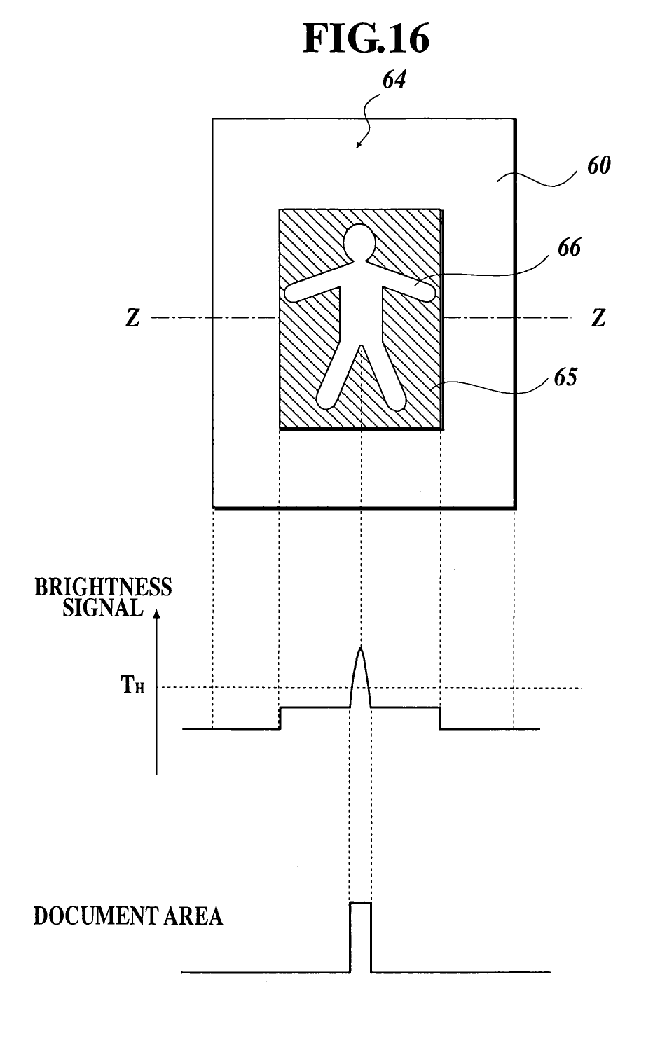

The non-rectangular document area detection process is effective in the case that a document shown in FIG. 14A or the like is to be read. As shown in FIG. 14B, when a document is to be read according to the rectangular document area detection process, since the smallest rectangular area including the document is detected as a document area, black output occurs around the actual document. On the other hand, when a document is to be read according to the non-rectangular document area detection process, an output result shown in FIG. 14C is obtained. Since an AND area between an effective image area in a previous line and an effective image area in a current line is determined as an estimated document area in the current line, a document area can be detected flexibly according to the shape of the document.

When the rectangular document area detection process (Step S9) or the non-rectangular document area detection process (Step S10) is completed, the image formation section 13 forms an image on the basis of the C, M, Y, K image data stored in the storage section 41 (Step S11).

According to the image reading device 12 in the present embodiment, since a document area is detected with the use of the three sensors having spectral sensitivity which respectively peaks at R, G, B on the basis of estimated document areas of each layered image data, a document area can be detected accurately even in the case that a document background is of deep blue, deep red or the like. In addition, since a color image sensor can be used for detecting a document area, it is possible to detect a document area according to the human visual property. Moreover, since a document is read on the basis of a document area detected by the document area detection section 37, an image can be read efficiently.

Furthermore, an OR area among estimated document areas of each layered image data is detected as a document area, the document area can be detected accurately according to simple calculation.

In addition, a threshold used for determining existence of a document image on each pixel can be changed, a document area can be detected flexibly according to a document and an environment.

Moreover, only when the platen cover 15 is in an opened state, the operation of detecting document is performed on the basis of a signal output from the platen cover open detection section 19. As a result, a read error can be prevented.

Furthermore, a threshold per each layered image data is set on the basis of an output from the image sensor 16 in the state that the platen cover 15 is opened and a document is not placed on the platen 14, that is to say, on the basis of the influence of external light. Accordingly, a document area can be detected according to an environment.

Here, the description in the present embodiment is one example of a suitable image reading apparatus 12 according to the present invention, and the present invention is not limited to the example.

And so forth, the detailed structure and operation of each section composing the image reading device 12 in the present embodiment may be accordingly changed without departing from the gist of the present invention.

For example, in the present embodiment, the image sensor 16 is used at both the pre scan and the main scan in the rectangular document area detection process. However, an image sensor for the pre scan and an image sensor for the main scan may be independently placed.

The entire disclosure of Japanese Patent Application No. Tokugan 2003-150954 filed on May 28, 2003 including specification, claims, drawings and summary are incorporated herein by reference in its entirety.

What is claimed is:

1. An image reading apparatus comprising:
a plurality of image sensors having different spectral characteristics from one another;
a layered image generation section for generating a plurality of pieces of layered image-data on the basis of an output from the plurality of image sensors;
a comparison section for comparing a threshold of each of the plurality of pieces of layered image data against a pixel value of each of the plurality of pieces of layered image data, the threshold being predetermined corresponding to each of the plurality of pieces of layered image data, and for judging existence of a document image on each pixel;
an estimated document area determination section for determining an estimated document area of each of the plurality of pieces of layered image data on the basis of a result of judging the existence by the comparison section;
a document area detection section for detecting a document area on the basis of the estimated document area of each of the plurality of pieces of layered image data; and
a document reading section for reading a document on the basis of the document area detected by the document area detection section.

2. The apparatus of claim 1, wherein the document area detection section detects an area included in any one of the estimated document area of each of the plurality of pieces of layered image data as the document area.

3. The apparatus of claim 1, wherein the plurality of image sensors include a color image sensor comprising three sensors having spectral sensitivity which respectively peaks at R (red), G (green) and B (blue).

4. The apparatus of claim 1, wherein the threshold of each of the plurality of pieces of layered image data is changeable.

5. The apparatus of claim 1, further comprising:
a platen on which the document is placed;
a platen cover openably mounted on the platen; and
a platen cover open detection section for detecting an opened state of the platen cover,
wherein operation of detecting the document is performed on the basis of a signal output from the platen cover open detection section.

6. The apparatus of claim 5, further comprising an automatic threshold setting section for setting the threshold of each of the plurality of pieces of layered image data on the basis of a signal output from the plurality of image sensors in a state that the platen cover open detection section detects the opened state of the platen cover and the document is not placed on the platen.

7. The apparatus of claim 1, wherein the estimated document area determination section determines an effective image area of each scan line on the basis of information regarding an area where not less than predetermined number of pixels which are judged as the pixel on which the document image exists by the comparison section are continuously lined up in each scan line, and determines a smallest rectangular area that includes all the effective image area of each scan line as the estimated document area.

8. The apparatus of claim 1, wherein the estimated document area determination section determines an effective image area of each scan line on the basis of information regarding an area where not less than predetermined number of pixels which are judged as the pixel on which the document image exists by the comparison section are continuously lined up in each scan line, and determines an area included in both an effective area in a previous line and an effective area in a current line as the estimated document area of the current line.

9. An image formation apparatus comprising:
a plurality of image sensors having different spectral characteristics from one another;
a layered image generation section for generating a plurality of pieces of layered image data on the basis of an output from the plurality of image sensors;
a comparison section for comparing a threshold of each of the plurality of pieces of layered image data against a pixel value of each of the plurality of pieces of layered image data, the threshold being predetermined corresponding to each of the plurality of pieces of layered image data, and for judging existence of a document image on each pixel;
an estimated document area determination section for determining an estimated document area of each of the plurality of pieces of layered image data on the basis of a result of judging the existence by the comparison section;
a document area detection section for detecting a document area on the basis of the estimated document area of each of the plurality of pieces of layered image data;
a document reading section for reading a document on the basis of the document area detected by the document area detection section; and
an image formation section for forming an image on the basis of image data of the document read by the document reading section.

10. A method for detecting a document area comprising:
generating a plurality of pieces of layered image data on the basis of an output from a plurality of image sensors having different spectral characteristics from one another;
comparing a threshold of each of the plurality of pieces of layered image data against a pixel value of each of the pieces of layered image data, the threshold being predetermined corresponding to each of the plurality of pieces of layered image data, for judging existence of an document image on each pixel;
determining an estimated document area of each of the plurality of pieces of layered image data on the basis of a result of judging the existence of the document image; and
detecting a document area on the basis of the estimated document area of each of the plurality of pieces of layered image data.

11. The method of claim 10, wherein the plurality of image sensors include a color image sensor comprising three sensors having spectral sensitivity which respectively peaks at R (red), G (green) and B (blue).

12. The method of claim 10, wherein the threshold of each of the plurality of pieces of layered image data is changeable.
